(19) United States
(12) Patent Application Publication
(10) Pub. No.: US 2026/0110368 A1
(43) Pub. Date: Apr. 23, 2026

(54) Adjustable Dual Stage Solenoid Valve

(71) Applicants: Zachary Stephan Sandstrom, Itasca, IL (US); Johan Furxhi, Itasca, IL (US); Javier Villanueva Martinez, Itasca, IL (US)

(72) Inventors: Zachary Stephan Sandstrom, Itasca, IL (US); Johan Furxhi, Itasca, IL (US); Javier Villanueva Martinez, Itasca, IL (US)

(21) Appl. No.: 19/308,522

(22) Filed: Aug. 25, 2025

Related U.S. Application Data
(60) Provisional application No. 63/710,636, filed on Oct. 23, 2024.

(51) Int. Cl. F16K 31/06

(52) U.S. Cl. CPC F16K 31/0658

(57) ABSTRACT

A dual stage solenoid valve has an ability to regulate selectively between one of two maximum flow/minimum pressure and minimum flow/maximum pressure settings, only. The solenoid moves an armature between one of two mechanical stops, neither of which hold the poppet on the valve seat apart from the bias of a first spring or diaphragm. The stops are preferably adjustably set by rotating a sleeve relative to a base for a second stop and a screw relative to the sleeve for a first stop.

### CLAIM OF PRIORITY

This application claims the benefit of U.S. Provisional Application No. 63/710,636 filed Oct. 23, 2024, which is incorporated by reference in its entirety.

### FIELD OF THE INVENTION

The present invention relates to solenoid valves, and more preferably to solenoid valves configured to change from high pressure/high flow rate to low pressure/low flow rate, preferably as a result of demand from an appliance.

### BACKGROUND OF THE INVENTION

Dual stage solenoid valves typically employ two diaphragms with two separate springs with a single solenoid. Adjustment screws are provided for each diaphragm and setting those screw limits sets the pressure and flow rates from an inlet to an outlet as is separately dictated by flow through past the respective diaphragm.

A competitor sells a combination gas servo valve which modulates flow between maximum and minimum outlet pressure seeking to provide a constant outlet pressure. However, a modulating servo valve operates very differently than a dual stage pressure valve. Specifically, modulating servo valves can position at an infinite number of positions between max and min positions to achieve a desired outlet pressure which is not how a dual stage pressure valve operates (a dual stage pressure valve can be positioned at one of only two positions or pressure options).

An improved dual stage solenoid valve is believed to be desirable for many applications in the marketplace.

### SUMMARY OF THE INVENTION

It is an object of many embodiments of the present invention to provide an improved dual stage solenoid having adjustable settings for the two stage positions.

It is an object of many embodiments of the present invention to have a solenoid valve providing first and second pressures with those first and second pressures being able to be adjusted.

Accordingly, in accordance with a presently preferred embodiment of the present invention, a dual stage valve has a solenoid operable between first and second positions whereby hard stops are provided at both the first and second positions. The hard stops are adjustable so that the flow/pressure at the hard stops may be adjusted. A single diaphragm is utilized with this design which selectively directs a poppet on and off a seat. When the solenoid is at the first position, the solenoid contacts the first hard stop. A minimum amount of pressure will be required to push the poppet of the seat, with the minimum pressure adjustable based on the positioning of the first hard stop.

A second hard stop is provided which, when the solenoid is set to the second position against the second hard stop, the diaphragm and poppet can move until sufficient resistance is met by the second hard stop to set a maximum flow and maximum pressure through the valve. The second hard stop position can be adjusted to set the maximum pressure/flow setting.

The solenoid must be in one of the first and second positions, to require either the minimum pressure/flow setting or the maximum pressure/flow setting. There are no intermediate positions provided by a solenoid valve (which differentiates a solenoid valve from a servo valve).

This is different than a modulating valve which effectively “hunts” a constant outlet pressure. With the applicants' design, one of two pressures is selected (a maximum or a minimum) with those specific pressures being adjustably selectable, but mechanically selectively and not by the electronics that change position of the valve. Whether the solenoid is switched from the first to second position (or second position to first position) is normally based on demands of an appliance attempting to select an ideal gas to air ratio.

For preferred embodiments, the poppet and diaphragm are located towards a bottom of a guide tube, if not below, where the hard stops are disposed, preferably colinearly with the poppet and diaphragm. The first hard stop may be encountered by the solenoid in a first position such as by having a sleeve received in the guide tube which cooperates with a base. The base may have inwardly directed threads, while a bottom of the sleeve has outwardly directed threads. An upper portion of the sleeve may extend out of the guide tube and potentially have flats. A wrench may contact opposing flats and permit twisting of the sleeve relative to the base. This moves the bottom of the sleeve linearly along guide tube axis so as to set the position of the first hard stop which is closer to the diaphragm than a second hard stop which will be explained in further detail below.

Selecting the first hard stop with the solenoid in the first position sets a first flow rate/first pressure which is believed to be a high or maximum pressure/flow.

An internal screw has outwardly directed threads which cooperate with inwardly directed threads of the sleeve. The screw can be positioned within the sleeve so that when the solenoid is moved away from the first position to a second position, the solenoid contacts a bottom of the screw which provides the second hard stop. The diaphragm and plunger can move a maximum distance off of seat with the plunger in the second position thereby establishing a minimum pressure/flow rate of the valve.

The valve receives a signal from an appliance as to whether the valve should be set to the maximum pressure/maximum flow setting, or to the minimum pressure/minimum flow setting with that signal then proving the signal to either turn on or off the solenoid valve so that it is in one of the two positions: maximum pressure/flow or minimum pressure/flow.

### BRIEF DESCRIPTION OF THE DRAWINGS

The particular features and advantages of the invention as well as other objects will become apparent from the following description taken in connection with the accompanying drawings in which:

FIG. 1 is a perspective view of a valve assembly having an adjustable dual stage valve of a presently preferred embodiment of the present invention with a cross section taken through the valve to show its internal portions; and

FIG. 2 is a detail A of FIG. 1 showing a portion of the cross section in more detail.

### DETAILED DESCRIPTION OF THE PREFERRED EMBODIMENTS

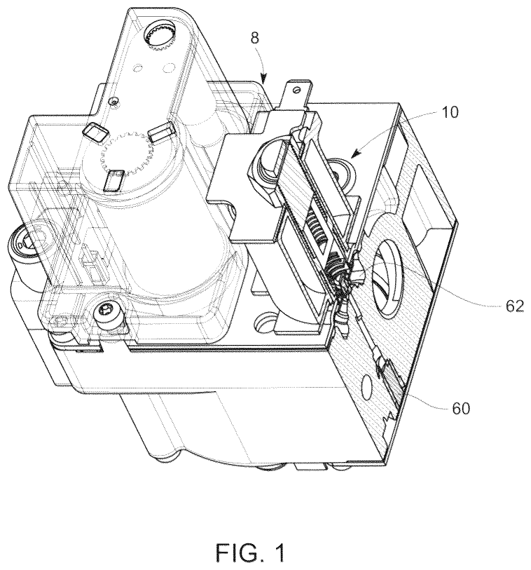

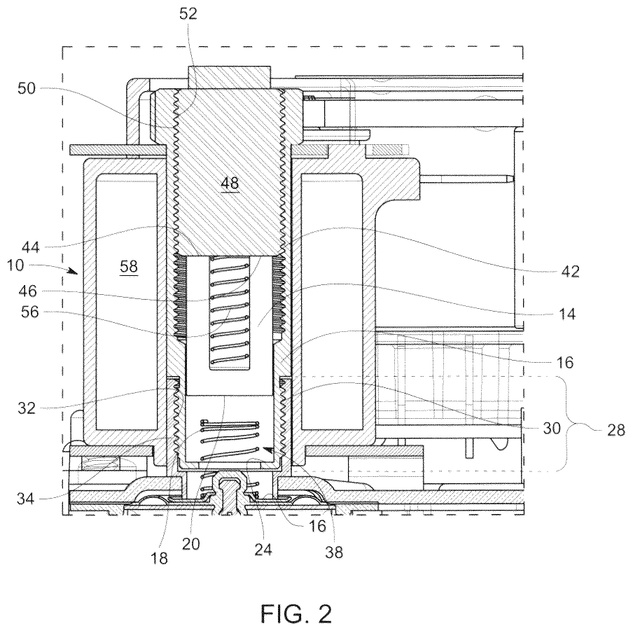

FIGS. 1 and 2 show an adjustable dual stage solenoid valve 10 as may be provided, possibly as a portion of a larger valve assembly 8.

The solenoid valve 10 has a valve seat 12 and a movable armature 14. The armature 14 contacts one of two adjustable stops as will be explained in further detail below depending on whether the solenoid is energized or not.

A diaphragm 16 is spring biased by first spring 18 which may, or may not, contact a bottom surface 20 of armature 14, possibly depending on the position of the armature 14. A poppet 22 may initially seal against valve seat 12 until a minimum pressure is reached, preferably with the armature 14 in a first position (represented by dotted lines in FIG. 2). The bottom surface 20 of armature 14 contacts stop surface 24 of sleeve 26. Sleeve 26 has a bottom portion 28 which may have outwardly directed threads 30 which may cooperate with inwardly directed threads 32 of base 34. Bore 36 through stop surface 24 may permit first spring 18 to contact bottom surface 20 of armature at the first stop 38. The elevation 40 of the first stop relative to the seat 12 may be set by turning the sleeve 26 relative to the base 34. As one of ordinary skill in the art will understand, this will then either increase or decrease the maximum pressure/minimum flow settings of the solenoid valve 10 in a first position. The higher the elevation 40, the lower pressure/higher flow at this setting.

FIG. 2 shows the valve 10 in a second position with the armature 14 at a second stop 42 with an upper surface 44 of armature 14 contacting a stop surface 46 of screw 48. Screw 48 has outer directed threads 50 which cooperate with inwardly directed threads 52 of sleeve 26 for the preferred embodiment. Twisting screw 48 relative to sleeve 26 sets the spacing or elevation 54 of second stop 42 relative to valve seat 12 to thus set a minimum pressure/maximum flow position. For many embodiments spring 18 will contact the bottom surface 20 in the minimum pressure/maximum flow position, but not all. In such situations, only the bias of the diaphragm 16 may dictate a minimum pressure until outlet pressure equals inlet pressure.

Whether the armature 14 is in a first or second position may be dictated by a gas appliance attempting to provide an ideal gas to air ratio. Depending upon the demands of the appliance, the valve 10 may be set to one of the two positions in an effort to achieve this ratio with the flow and pressure being drastically different depending upon which position is selected, which is very different from servo valves which would attempt to maintain a constant outlet pressure.

Bias spring 56 may be useful to position armature 14 in a desired one of the first and second positions. Depending on whether the armature 14 is in the second position when coils 58 are energized or in the first position when energized, the bias spring 56 may assist in directing the armature to the other position when the armature is de-energized.

Poppet 22 is shown on valve seat 12 in FIG. 1 thereby securing flow from inlet 60 to outlet 62. With the bias of spring 18 and/or diaphragm 16 overcome, flow proceeds from inlet 60 out outlet 62 at one of the two settings as described above, either at a maximum pressure/flow rate or at a minimum pressure/flow rate.

The valve 10 can only operate at one of the two positions since the solenoid is either energized or de-energized. The solenoid does not modulate like servo valves.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A dual stage solenoid valve comprising:
a valve seat;
a poppet with said poppet sealing against the valve seat in a closed configuration;
an armature of a solenoid movable to selectively contact only one of either a first and a second mechanical stop;
a first spring intermediate the poppet and the armature;
wherein the force of the first spring on the poppet when the armature is at the second stop is greater than when at the first stop;
and when the armature is at the first stop, a minimum pressure to move the poppet off the valve seat is provided by the valve, and when the armature is at the second stop a maximum pressure is provided by the valve, and the poppet is not restrained to the closed configuration other than by the biasing member acting on the poppet.

2. The dual stage solenoid valve of claim 1 further comprising a diaphragm connected to the poppet.

3. The dual stage solenoid valve of claim 2 wherein the first spring is intermediate the diaphragm and the armature.

4. The dual stage solenoid valve of claim 1 further comprising a bias spring directing the armature to one of the first and second mechanical stops when the solenoid is de-energized.

5. The dual stage solenoid valve of claim 1 further comprising a base and a sleeve, said sleeve rotatable relative to the base whereby rotation moves the sleeve linearly relative to the base and the sleeve provides the second mechanical stop to the armature thereby permitting adjustment of the maximum pressure through the valve.

6. The dual stage solenoid of claim 5 further comprising a screw received within the sleeve, said screw providing the first mechanical stop to the armature.

7. The dual stage solenoid of claim 6 wherein the screw is rotatable relative to the base whereby rotation moves the screw linearly relative to the sleeve thereby permitting adjustment of the minimum pressure through the valve.

8. The dual stage solenoid of claim 7 wherein linear motion of the sleeve relative to the base and screw relative to the sleeve are coaxial.

9. The dual stage solenoid of claim 6 wherein a bottom surface of the screw contacts an upper surface of the armature when at the first mechanical stop.

10. The dual stage solenoid of claim 5 wherein the base has a bore permitting passage of the first spring therethrough.

11. The dual stage solenoid of claim 3 wherein the first spring contacts the bottom surface of the armature.

12. A dual stage solenoid valve comprising:
a valve seat;
a poppet held by a diaphragm with said poppet sealing against the valve seat in a closed configuration;
an armature of a solenoid movable to selectively contact only one of either a first and a second mechanical stop;
a first spring intermediate the poppet and the armature;
wherein when the armature is at the first stop, a minimum pressure to move the poppet off the valve seat is provided by the valve, and when the armature is at the second stop a maximum pressure is provided by the valve, and the poppet is not restrained to the closed configuration other than by one of the diaphragm and the biasing member acting on the poppet.

13. The dual stage solenoid valve of claim 12 wherein the force of the first spring on the poppet when the armature is at the second stop is greater than when at the first stop.

14. The dual stage solenoid valve of claim 12 wherein the first spring is intermediate the diaphragm and the armature.

15. The dual stage solenoid valve of claim 12 further comprising a bias spring directing the armature to one of the first and second mechanical stops when the solenoid is de-energized.

16. The dual stage solenoid valve of claim 12 further comprising a base and a sleeve, said sleeve rotatable relative to the base whereby rotation moves the sleeve linearly relative to the base and the sleeve provides the second mechanical stop to the armature thereby permitting adjustment of the maximum pressure through the valve.

17. The dual stage solenoid of claim 16 further comprising a screw received within the sleeve, said screw providing the first mechanical stop to the armature.

18. The dual stage solenoid of claim 17 wherein the screw is rotatable relative to the base whereby rotation moves the screw linearly relative to the sleeve thereby permitting adjustment of the minimum pressure through the valve.

19. The dual stage solenoid of claim 18 wherein linear motion of the sleeve relative to the base and screw relative to the sleeve are coaxial.

20. The dual stage solenoid of claim 14 wherein the first spring contacts the bottom surface of the armature.
